(19) United States
(12) Patent Application Publication
(10) Pub. No.: US 2008/0008840 A1
(43) Pub. Date: Jan. 10, 2008

(54) Method of manufacturing a metal pattern

(75) Inventors: Kentaro Suzuki, Kawasaki (JP); Masanori Tachibana, Kawasaki (JP); Yukinori Ikegawa, Kawasaki (JP)

Correspondence Address: Patrick G.Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/545,695

(22) Filed: Oct. 10, 2006

(30) Foreign Application Priority Data
Jun. 22, 2006 (JP) 2006-172396

(51) Int. Cl. B05D 7/00

(52) U.S. Cl. 427/402; 204/192.1

(57) ABSTRACT

Even when materials with different grinding rates, such as a metal layer and an insulating layer, are present on a substrate, a method of manufacturing can grind the surface of the substrate to form a flat surface and can grind the metal layer to a predetermined thickness without fluctuations. The method includes a step of forming an insulating film on a substrate surface to cover a surface of a metal layer that has a predetermined pattern and then forming a stopper film on a surface of the insulating film; a step of forming a resist pattern that exposes only bulging parts of the insulating film that cover the metal layer and then removing the stopper film from the surface of the bulging parts to form a stopper layer on a surface of the insulating film covered by the resist pattern; a grinding step of grinding the surface of the substrate to grind the bulging parts as far as a position regulated by the stopper layer; and a step of removing the stopper layer from the surface of the insulating film and then carrying out finish-up grinding on the surface of the substrate.

### BACKGROUND OF THE INVENTION

1. Field of the Invention

The present invention relates to a method of manufacturing a metal pattern such as a magnetic layer formed on a magnetic head, and in more detail to a method of manufacturing a metal pattern characterized by a grinding process that makes the surface of a substrate flat during the manufacturing of a metal pattern.

2. Related Art

FIG. 4 shows the construction of a magnetic head used in a magnetic disk apparatus when looking from the floating surface side of the magnetic head. The magnetic head includes a read head 8, where a reproduction MR element 12 is sandwiched between a lower shield layer 10, which is composed of a magnetic material on a substrate, and an upper shield layer 14, and a write head 18 that includes a lower magnetic pole 15a and an upper magnetic pole 17 disposed on either side of a write gap 16. Note that in the illustrated magnetic head, the upper shield layer 14 also serves as the lower magnetic pole of the write head 18.

During the manufacturing of the magnetic head, processes are carried out to form a magnetic layer that forms a shield layer, various layers that construct the reproduction element, an insulating layer, a magnetic layer that forms a magnetic pole, a conductive layer that forms a recording coil, and the like by a dry process or by plating on the surface of a wafer made of ceramic. Since such processes include a step that etches or patterns the magnetic layer and/or the conductive layer, it is necessary to make the surface of the work flat so that patterning can be carried out with high precision when forming resist patterns by photolithography.

As one example of a process that makes the surface of a wafer flat, FIGS. 3A to 3D show a process where the lower shield layer 10 is formed on the surface of the wafer (see FIG. 3A), alumina is then sputtered as an insulating film 11 (see FIG. 3B), a rough grinding is initially carried out (see FIG. 3C) and then grinding is carried out by CMP (Chemical Mechanical Polishing) to produce the intended thickness (FIG. 3D). Since the lower shield layer 10 is formed at each formation position of a magnetic head on the wafer, the magnetic layer that forms the lower shield layer 10 is formed in a predetermined pattern on the surface of the wafer. By sputtering alumina at the positions where the lower shield layers 10 are formed, bulging parts 11a are formed where the insulating film 11 protrudes outward by the thickness of the lower shield layer 10. If the work is ground in this state, the bulging parts will be ground and become flattened first, resulting in the surface of the lower shield layer 10 becoming exposed.

### Patent Document 1

Japanese Laid-Open Patent Publication No. H08-306804

### SUMMARY OF THE INVENTION

As shown in FIGS. 3A to 3D, during the manufacturing of a magnetic head, a metal layer used as a magnetic layer or the like is formed on the surface of a substrate, an insulating material such as alumina is sputtered onto the entire surface of the substrate, and a grinding process that grinds the insulating film to expose the surface of the metal layer and make the entire surface of the substrate flat is often carried out. In particular, since the MR element 12 is formed on the lower shield layer 10 that constructs the read head 8, high precision is required for the surface flatness of the lower shield layer 10 and the insulating film 11. Also, since the recording density of media has greatly increased in recent years, it has become necessary to control the thicknesses of the layers that construct a magnetic head more strictly.

Conventionally, as shown in FIGS. 3A to 3D, when grinding a work on which materials with different grinding rates, such as alumina and a magnetic material, are present, a method is used where the grinding is divided into a plurality of stages and as one example, rough grinding is carried out when grinding the insulating film 11 and then a “finish-up grinding” is carried out to expose the surface of the lower shield layer 10 and reach the desired thickness with high precision. As shown in FIGS. 3A to 3D, when polishing a work where the insulating film 11 includes bulging parts that protrude due to the metal layer (the lower shield layer 10), the bulging parts of the insulating film 11 are flattened by the grinding and simultaneously the lowest parts of the insulating film 11 that have no metal layer therebelow are also slightly ground. Also, during grinding, parts where the bulging parts are flattened and parts where the bulging parts are not completely flattened are produced on the work, and since grinding proceeds more quickly at parts that have been flattened, there is increased fluctuation in the thickness after grinding.

Also, since the finish-up grinding is carried out after the bulging parts of the insulating film 11 have been flattened across the entire work, at a stage where the thickness of the insulating film 11 is thin and bulging parts of the insulating film 11 have been flattened, there is the risk of parts of the metal layer being ground due to the fluctuations in the grinding, resulting in the thickness of the metal layer becoming thinner than the desired thickness during the finish-up grinding. For this reason, in conventional methods the insulating film 11 is formed thickly. As a result, there has been the problem that there is greater fluctuation in the thickness when the insulating film is formed and greater fluctuation in the thickness after grinding due to the increased amount by which the insulating film is ground.

It is an object of the present invention to provide a method of manufacturing a metal pattern that can grind the surface of a substrate with high precision even when materials with different grinding rates, such as a metal layer and an insulating layer, are present on the surface of the substrate, can finish up the surface of the substrate to a predetermined flatness, and can finish up a metal layer such as a lower shield layer without fluctuations in thickness.

To achieve the stated object, a method of manufacturing a metal pattern according to the present invention includes: a step of forming an insulating film on a substrate surface to cover a surface of a metal layer that has a predetermined pattern and then forming a stopper film on a surface of the insulating film; a step of forming a resist pattern that exposes only bulging parts of the insulating film that cover the metal layer and then removing the stopper film from the surface of the bulging parts to form a stopper layer on a surface of the insulating film covered by the resist pattern; a grinding step of grinding the surface of the substrate to grind the bulging parts as far as a position regulated by the stopper layer; and a step of removing the stopper layer from the surface of the insulating film and then carrying out finish-up grinding on the surface of the substrate.

Alumina may be sputtered to form the insulating film and tantalum may be sputtered to form the stopper film.

The metal layer may be a lower shield layer of a read head and alumina may be sputtered to form the insulating film.

With the method of manufacturing a metal pattern according to the present invention, by providing a stopper film on the surface of the insulating film aside from the bulging parts of the insulating film, it is possible to easily and reliably flatten the bulging parts of the insulating film. By carrying out finish-up grinding after the stopper layer has been removed, it is possible to flatten the surface of the substrate with high precision and to grind the metal layer to a predetermined thickness with high precision. By doing so, it is possible to improve the precision of the thickness and the patterning of a magnetic layer or the like that constructs a magnetic head, so that a metal pattern can be formed with high precision.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIGS. 1A to 1F are diagrams useful in explaining steps up to the formation of a stopper layer on a substrate;

FIGS. 2A to 2C are diagrams useful in explaining steps up to grinding the lower shield layer to a predetermined thickness;

FIGS. 3A to 3D are diagrams useful in explaining steps showing conventional grinding; and

FIG. 4 is an end view showing the construction of a magnetic head when looking from a floating surface side thereof.

### DESCRIPTION OF THE PREFERRED EMBODIMENTS

Preferred embodiments of the present invention will now be described in detail with reference to the attached drawings.

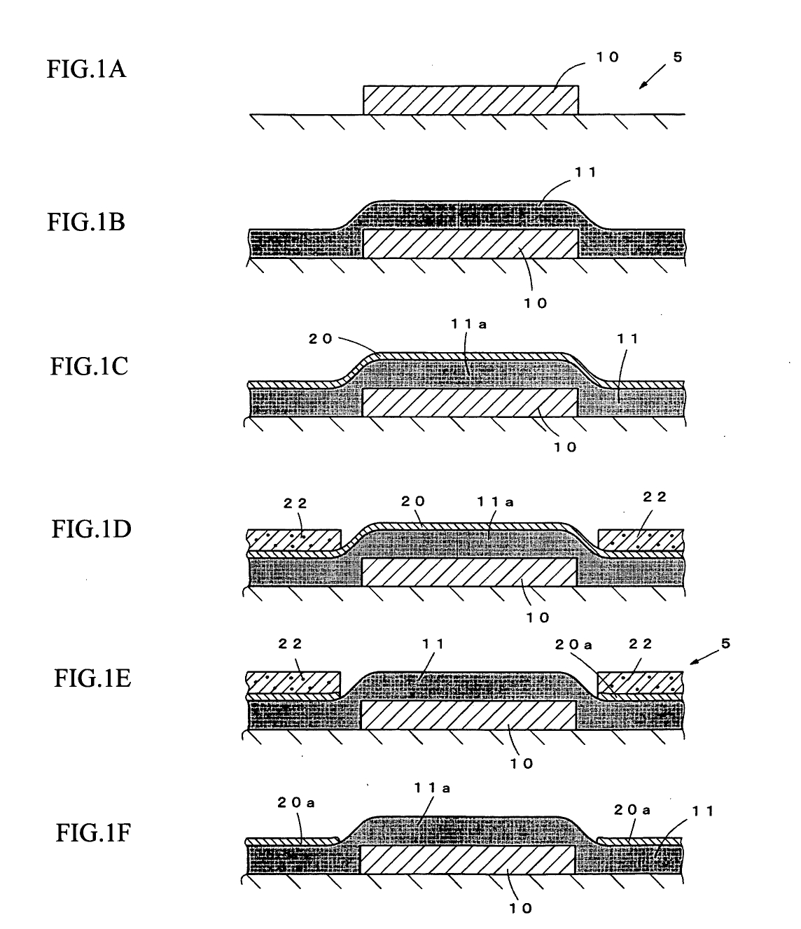

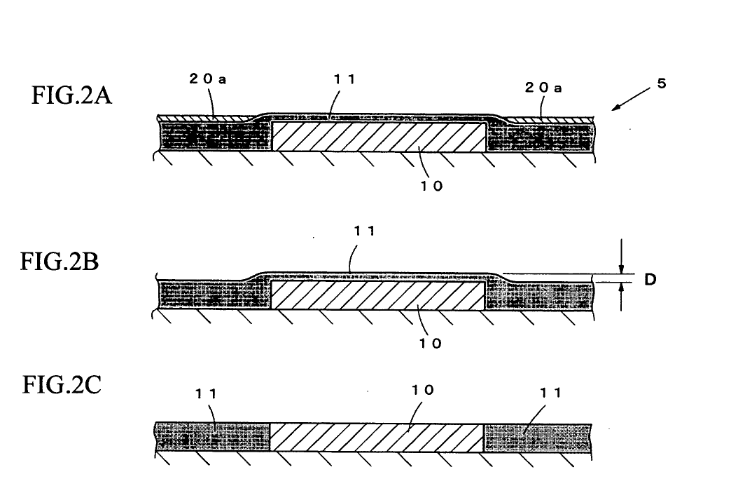

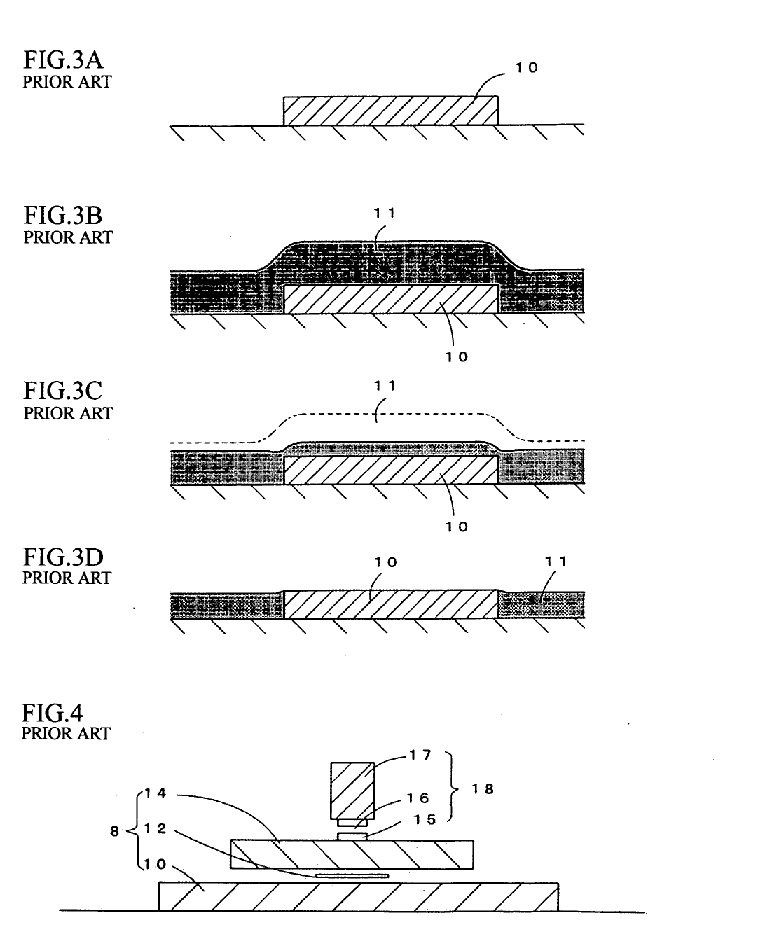

FIGS. 1A to 1E and FIGS. 2A to 2C show a process that forms a lower shield layer 10 of a magnetic head as an example application of a method of manufacturing a metal pattern according to the present invention.

FIG. 1A shows a state where a magnetic layer has been formed on the surface of a substrate 5 and the magnetic layer has been patterned into a predetermined pattern to form the lower shield layer 10. The lower shield layer 10 is formed by electroplating a magnetic material such as an NiFe type material. The thickness of the lower shield layer 10 is around 2 to 3 μm.

Next, to flatten the surface of the substrate 5 on which the lower shield layer 10 has been formed, the surface of the substrate 5 is covered with the insulating film 11. FIG. 11B shows a state where the surface of the substrate 5 has been covered with the insulating film 11. On the lower shield layer 10, alumina is used as the insulating film 11. Alumina is sputtered with the same thickness as the lower shield layer 10 or slightly more thickly than the lower shield layer 10 to form the insulating film 11 across the entire surface of the substrate.

When alumina has been sputtered onto the surface of the substrate, as shown in FIG. 1B, at parts where the lower shield layer 10 is formed, the insulating film 11 is formed so as to bulge outward by the thickness of the lower shield layer 10.

After the surface of the substrate has been covered by the insulating film 11, the entire surface of the substrate is covered by a stopper film. The stopper film is formed with a thickness of around 30 nm to achieve a required barrier effect. FIG. 1C shows a state where the surface of the insulating film 11 has been covered by the stopper film 20.

Next, to form the stopper film 20 into a stopper layer 20a used during grinding, the surface of the substrate 5 is covered with a resist, and the resist is then exposed to light and developed to pattern the resist so as to expose bulging parts 11a of the insulating film 11 where the lower shield layer 10 is formed below, thereby forming the resist pattern 22 (see FIG. 1D).

Next, exposed parts of the stopper film 20 are etched and removed with the resist pattern 22 as a mask (see FIG. 1E) and then the resist pattern 22 is removed (see FIG. 1F). In this way, the stopper film 20a is formed on the surface of parts of the insulating film 11 aside from the bulging parts 11a, such parts being formed with approximately the same thickness as the lower shield layer 10.

FIGS. 2A to 2C show steps in a flattening process where grinding is carried out on the substrate 5 on which the stopper layer 20a has been formed.

FIG. 2A shows a state where grinding has been carried out on the surface of the substrate 5 in the state shown in FIG. 1F to flatten the bulging parts 11a of the insulating film 11. When grinding is carried out on the substrate 5, parts that protrude from the surface of the substrate 5 are ground first. In the present embodiment, since parts aside from the bulging parts 11a of the insulating film 11 are covered by the stopper layer 20a, when grinding is carried out on the substrate 5, the parts of the insulating film 11 covered by the stopper layer 20a are protected from being ground. The bulging parts 11a of the insulating film 11 become gradually flatter as the grinding proceeds.

FIG. 2A shows a state where the bulging parts 11a of the insulating film 11 are ground and grinding proceeds until the bulging parts 11a have substantially the same thickness as the surface of the stopper layer 20a. That is, when the stopper layer 20a is provided on the substrate 5 and the surface of the substrate 5 is ground, the bulging parts 11a are flattened using the stopper layer 20a so that the bulging parts 11a are ground until the height of the bulging parts 11a becomes approximately equal to the stopper layer 20a. Note that since the bulging parts 11a of the insulating film 11 are not covered by the stopper layer 20a, if the grinding is allowed to proceed, the lower shield layer 10 will become exposed and will then be ground to become concave.

In this way, even when the stopper layer 20a has been formed, step-like fluctuations in thickness are produced due to the fluctuations in the thickness of the insulating film 11 and the like so that on the surface of the substrate 5, the lower shield layer 10 may be exposed or not exposed. However, when grinding is carried out with the stopper layer 20a having been provided, the fluctuations in thickness across the entire surface of the substrate 5 are greatly reduced compared to the conventional method where bulging parts 11a are formed across the entire substrate. Accordingly, the finish-up grinding carried out afterward can make the difference in thickness between the lower shield layer 10 and the insulating film 11 uniform with high precision across the entire substrate 5.

Since a large number of magnetic heads are fabricated on the substrate 5 and a lower shield layer 10 is formed with a predetermined pattern at each formation position of a magnetic head, during the flattening process carried out on the substrate 5, it is necessary to make the substrate 5 flat with no fluctuations. This means that in the present embodiment, even if the lower shield layer 10 becomes exposed at some positions and not at others and/or steps are produced between the lower shield layer 10 and the insulating film 11 when the surface of the substrate 5 has been ground, by carrying out the finish-up grinding, it is possible to make the thicknesses of the lower shield layer 10 and the insulating film 11 uniform. Excessive grinding of the lower shield layer 10 can be prevented by changing the grinding conditions, so that fluctuations in thickness can be minimized across the entire substrate 5.

Since the stopper layer 20a acts so as to regulate the thickness of the lower shield layer 10 and the insulating film 11, when the bulging parts 11a of the insulating film 11 are ground, it is possible to carry out the grinding process without worrying about whether the lower shield layer 10 or required parts of the insulating film 11 will be ground. Since the bulging parts 11a and also the lowest parts of the insulating film 11 are ground when the bulging parts 11a of the insulating film 11 are ground according to the conventional method, it was necessary to make the insulating film thicker. On the other hand, when the stopper layer 20a is provided as with the present embodiment, the stopper layer 20a serves as a standard position for regulating the grinding position. As a result, the bulging parts 11a of the insulating film 11 are preferentially flattened and it is unnecessary to make the insulating film 11 thicker. By doing so, it is possible to suppress fluctuations in the thickness of the insulating film 11 and to reduce fluctuations in the thickness of the insulating film 11 after the insulating film 11 has been ground.

It should be noted that even if the stopper layer 20a is provided, in reality it is necessary to control the grinding so that the stopper layer 20a is not excessively ground away. As the material of the stopper film 20, it is possible to use tantalum, for example. Tantalum is effective as a stopper film since the grinding rate of tantalum is lower than that of alumina, and is also effective since tantalum is non-magnetic and therefore does not adversely affect the magnetic characteristics of the magnetic head. In this way, it is sufficient to choose a material with a lower grinding rate than the material that constructs the insulating film 11 as the stopper film 20.

FIG. 2B shows a state where the stopper layer 20a remaining on the surface of the substrate 5 has been removed after the grinding process that uses the stopper layer 20a as the standard position. The stopper layer 20a is removed by plasma etching or chemical etching. In FIG. 2B, the lower shield layer 10 is covered by the insulating film 11 and is not exposed, but even if the surface of the lower shield layer 10 becomes exposed at this stage, the grinding process can be carried out in the same way thereafter.

After the stopper layer 20a has been removed, a finish-up grinding process is carried out on the surface of the substrate 5 to make the lower shield layer 10 a predetermined thickness and to make the surfaces of the lower shield layer 10 and the insulating film 11 flat. Since the lower shield layer 10 is already formed with a predetermined thickness during the formation process, the finish-up grinding flattens the difference in thickness (i.e., the stepped parts) between the lower shield layer 10 and the insulating film 11 produced when the stopper layer 20a is removed to make the height of the entire substrate 5 uniform.

The difference in thickness between the lower shield layer 10 and the insulating film 11 when the stopper layer 20a has been removed is around several tens of nanometers, so that the finish-up grinding only needs to grind the surface by a tiny amount. This means it is easy to suppress fluctuations in the amount of grinding across the entire substrate 5 due to the finish-up grinding.

With the grinding method according to the present embodiment, compared to a method where grinding is carried out in a state where the bulging parts 11a have been formed in the insulating film 11 and continues until the lower shield layer 10 is ground to a predetermined thickness, during the grinding process with the larger amount of grinding, such as when grinding the bulging parts 11a of the insulating film 11, the stopper layer 20a acts so as to suppress fluctuations in the amount of grinding across the entire substrate 5. During the finish-up grinding carried out after the stopper layer 20a has been removed, by carrying out only a small amount of grinding starting from a state where the entire surface of the substrate 5 has been ground to become substantially flat until a finished position is reached, it is possible to flatten the substrate 5 with high precision.

When the conventional method and the method of the present invention are compared, the Range/Average of the fluctuation in the thickness after grinding was 10 to 20% with the conventional method, but is improved to 4 to 8% with the present method.

As described above, when carrying out a flattening process that grinds a substrate on which materials with different grinding rates, such as a metal layer (e.g., the lower shield layer) and an insulating layer of alumina or the like are present, by dividing the process into a grinding process that carries out grinding with the grinding position regulated by a stopper film and a machining process that carries out a finish-up grinding after the stopper film has been removed to produce the metal layer with the desired thickness, the substrate can be flattened with high precision. The embodiment described above is an example of a process where the surface of a substrate is flattened during a step that forms the lower shield layer, but it is also possible to apply the same method when flattening the surface of a formed layer beforehand, such as when forming an upper shield layer, a magnetic pole or the like of a write head, and/or when forming a recording coil.

If the surface of a substrate can be flattened with high precision, when forming a magnetic film or the like on the surface of the substrate, it will be possible to form the film precisely without fluctuations, and when patterning a magnetic layer or a conductive layer, it is possible to suppress curvature of the substrate surface and fluctuations in thickness, and therefore patterning can be carried out with high precision. As the recording density of recording media increases, even higher precision becomes necessary for the thickness and machining precision of the magnetic head. The method according to the present invention can be effectively used as the manufacturing process of a magnetic head where high machining precision is required.

What is claimed is:

1. A method of manufacturing a metal pattern, comprising:
a step of forming an insulating film on a substrate surface to cover a surface of a metal layer that has a predetermined pattern and then forming a stopper film on a surface of the insulating film;
a step of forming a resist pattern that exposes only bulging parts of the insulating film that cover the metal layer and then removing the stopper film from the surface of the bulging parts to form a stopper layer on a surface of the insulating film covered by the resist pattern;
a grinding step of grinding the surface of the substrate to grind the bulging parts as far as a position regulated by the stopper layer; and
a step of removing the stopper layer from the surface of the insulating film and then carrying out finish-up grinding on the surface of the substrate.

2. A method of manufacturing a metal pattern according to claim 1,
wherein alumina is sputtered to form the insulating film and tantalum is sputtered to form the stopper film.

3. A method of manufacturing a metal pattern according to claim 1,
wherein the metal layer is a lower shield layer of a read head and alumina is sputtered to form the insulating film.
